(19) United States
(12) Patent Application Publication
(10) Pub. No.: US 2010/0266779 A1
(43) Pub. Date: Oct. 21, 2010

(54) PAINTER APPARATUS AND METHOD

(76) Inventor: Nazrelee N. Dunham, Mastic, NY (US)

Correspondence Address: Mr. Walter J. Tencza Jr., Suite 210, 100 Menlo Park, Edison, NJ, 08837, US

(21) Appl. No.: 12/427,176

(22) Filed: Apr. 21, 2009

(51) Int. Cl. B05D 1/28; B05C 11/00

(52) U.S. Cl. 427/429; 118/264

(57) ABSTRACT

A base having a top surface having an area, a handle, a means for attaching the base to the handle, and a cover are provided for painting. The cover may be substantially in the shape of a bag, having a portion at a bottom of the bag, and a plurality of side walls substantially perpendicular to and attached to the portion at the bottom of the bag, so that the portion and the plurality of sidewalls enclose a chamber. The portion of the cover may have a top section made of a material which absorbs paint and allows paint to permeate through the top section. The portion of the cover may include a bottom section made of a material which does not allow paint to permeate through the bottom section.

### FIELD OF THE INVENTION

This invention relates to improved methods and apparatus concerning painting.

### BACKGROUND OF THE INVENTION

There are various devices known in the prior art for painting.

### SUMMARY OF THE INVENTION

One or more embodiments of the present invention provide an apparatus for painting comprising a base having a top surface having an area, a handle, a means for attaching the base to the handle, and a cover. The cover may be substantially in the shape of a bag, having a portion at a bottom of the bag, and a plurality of side walls substantially perpendicular to and attached to the portion at the bottom of the bag, so that the portion and the plurality of sidewalls enclose a chamber.

The portion of the cover may have a top section made of a material which absorbs paint and allows paint to permeate through the top section. The top section of the portion of the cover may have an area which is approximately equal to the area of the top surface of the base. The base and the cover may be configured so that the base can be placed inside of the chamber of the cover, so that the sidewalls of the cover surround the base, and the portion of the cover substantially overlaps the top surface of the base. The portion of the cover may include a bottom section made of a material which does not allow paint to permeate through the bottom section.

The side walls of the cover may be made of a fabric. The side walls of the cover may be made of an elastic material. The base may be rectangular and approximately six inches in length and four feet in width. An elastic band may be attached to the side walls, so that the elastic band holds the cover to the base when the cover is placed over the base.

In at least one embodiment of the present invention, a pan is provided. The pan may have at least a first compartment and a second compartment, wherein each of the first and the second compartments are able to retain paint. The base may be configured to fit within either the first or the second compartment. The base may be inserted into the first compartment to cause paint to be absorbed by a top section of a portion of the cover. The base may be inserted into the second compartment to squeeze excess paint off of the top section of the portion of the cover.

The means for attaching the base to the handle may include grooves located on the base and grooves located on the handle. The handle may be flexible. The handle may have a means for adding a further handle to the handle to effectively elongate the handle.

One or more embodiments of the present invention may also include a method comprising attaching a handle to a base, attaching a cover to the base, causing paint to be absorbed by a top section of a portion of the base, and transferring paint from the top section of the portion of the base to a surface.

### BRIEF DESCRIPTION OF THE DRAWINGS

FIG. 1A shows a top perspective view of a painter apparatus in accordance with an embodiment of the present invention, with the painter apparatus shown in a disassembled form;

FIG. 1B shows a bottom perspective view of a handle for use with the painter apparatus of FIG. 1A;

FIG. 1C shows a top perspective view of the painter apparatus of FIG. 1A, with the painter apparatus shown in an assembled form;

FIG. 1D shows a top orthogonal view of a base of the painter apparatus of FIG. 1A;

FIG. 2A shows a top orthogonal view of a cover for covering the base shown in FIG. 1D;

FIG. 2B shows a top perspective view of the cover of FIG. 2A;

FIG. 2C shows a bottom orthogonal view of the cover of FIG. 2A;

FIG. 3A shows a top perspective view of the cover of FIG. 2A and the painter apparatus of FIG. 1A in a state where they are not attached together;

FIG. 3B shows a top perspective view of the cover of FIG. 2A and the painter apparatus of FIG. 1A in a state where they are attached together; and

FIG. 4 shows a top perspective view of a pan which can be used with the cover of FIG. 2A and painter apparatus of FIG. 1A in accordance with an embodiment of the present invention.

### DETAILED DESCRIPTION OF THE DRAWINGS

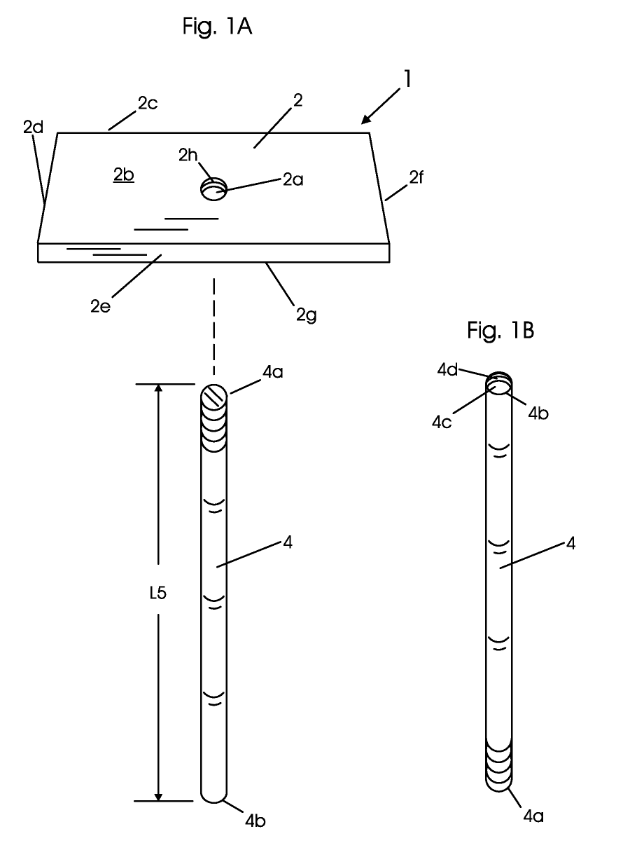

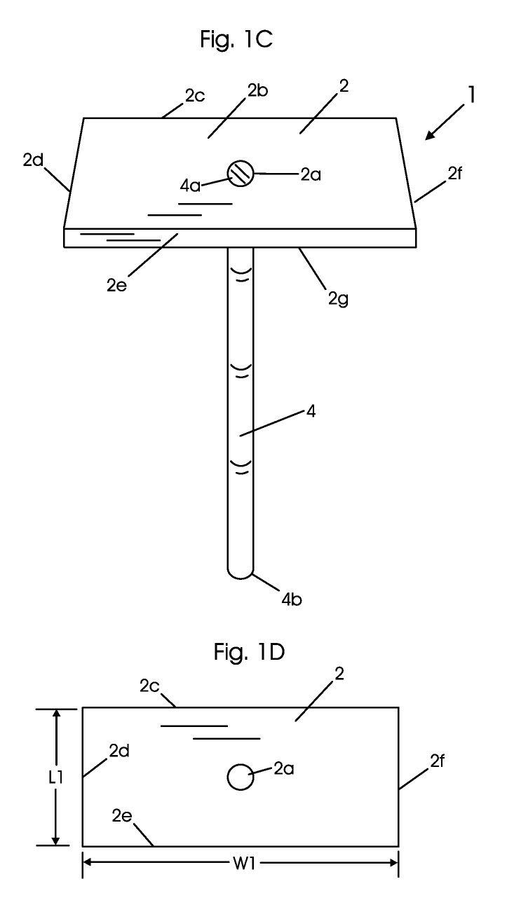

FIG. 1A shows a top perspective view of a painter apparatus 1 in accordance with an embodiment of the present invention, with the painter apparatus 1 shown in a disassembled form. FIG. 1B shows a handle 4 of the painter apparatus 1 with the handle 4 upside down with respect to the FIG. 1A. FIG. 1C shows a top perspective view of the painter apparatus 1 of FIG. 1A, with the painter apparatus 1 shown in an assembled form. FIG. 1D shows a top orthogonal view of a base 2 of the painter apparatus 1 of FIG. 1A.

The painter apparatus 1 includes a handle 4 and the base 2. The base 2 may be rectangular in shape and may have a top surface 2b, a bottom surface 2g, and sides 2c, 2d, 2e, and 2f. The base 2 may have an opening 2a. An interior 2h surrounding the opening 2a may have threads or grooves.

The painter apparatus 1 also includes the handle 4 shown in FIGS. 1A, 1B, and 1C. The handle 4 may include ends 4a and 4b. There may be exterior threads or grooves at end 4a which may be flexible and/or bendable and can be screwed into the interior threads or grooves 2h which surround the opening 2a. The end 4a and a portion of the handle 4 may be inserted and/or screwed into the opening 2a. The handle 4 may also have an opening 4c at end 4b, shown in FIG. 1B. The opening 4c may be surrounded by interior threads or grooves 4d, into which another handle or pole, with an exterior grooved or threaded end can be inserted to add to the length of handle 4.

The base 2 may be made of various materials, such as plastic, wood, aluminum, a synthesized product of wood, or with various other materials. The base 2 can be of a fixed size or can be replaced by an expandable device such as an expandable device known in the art. If the base 2 is of a fixed size, the base 2 may have a length, L1, shown in FIG. 1C of about six inches and a width, W1, shown in FIG. 1C, of about four feet. The base 2 can be other sizes depending on the area to be painted. If the base 2 is of an expandable type, it may have a fully compressed or smallest state with the size of L1, of about six inches, and W1, of about four feet and may expand in length or width to a larger size. The top surface 2b may be a flat surface.

The handle 4, may be of fixed size or may be a telescoping or expandable handle as known in the art. Alternatively, an additional fixed size handle or pole may be added to the end 4b, to add to the length of the handle 4 and to effectively create a longer handle. The handle 4 may have a fixed length of four feet from end 4a to end 4b, or if of an expandable or telescoping type, the handle 4 may have a fully compressed or shortest state of about four feet. The handle 4 may have a fixed length, L5, or a fully compressed telescoping length L5, which is shorter in length or longer in length than four feet from end 4a to end 4b. The handle 4 may have a circumference of three and one quarter inches.

The handle 4 may be made of a material, such as ABS (Acrylonitrile butadiene styrene), plastic, plastic combination or any material that is sturdy and/or flexible. The handle 4 may be made of various materials, such as plastic, wood, aluminum, or a synthesized product of wood. Typically, the handle 4 should be rigid enough so that when it is attached to the base 2, and a person holds the handle in a horizontal orientation with respect to ground, and off of the ground by only the end 4b, the handle 4 should not bend significantly. However, in at least one embodiment, the handle 4 may have a portion near end 4a, where grooves are located, which is flexible, and a portion for the rest of the handle 4, which may be non-flexible, i.e. unbendable.

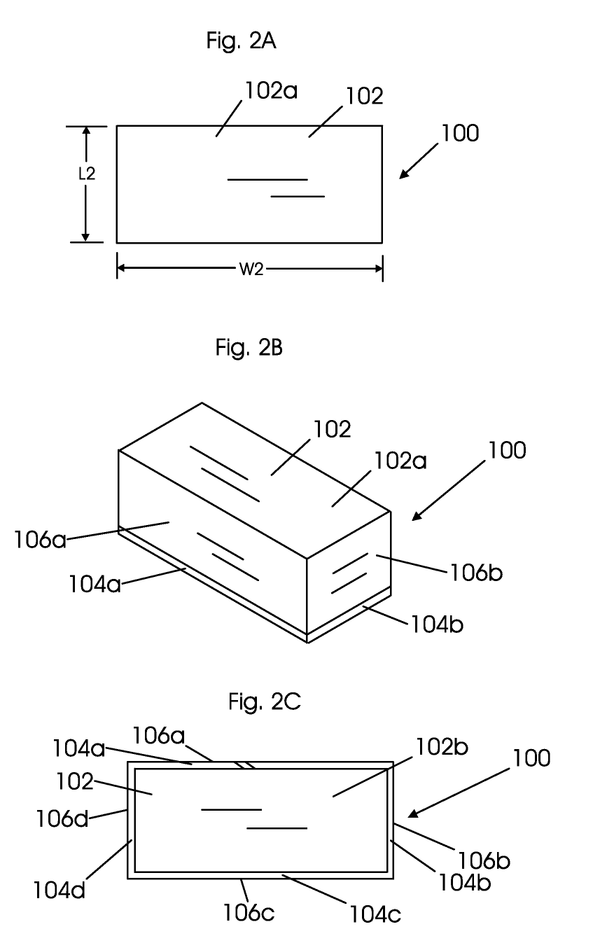

FIG. 2A shows a top orthogonal view of a cover 100 for covering the base 2 of FIG. 1A. FIG. 2B shows a top perspective view of the cover 100. FIG. 2C shows a bottom orthogonal view of the cover 100 of FIG. 2A.

The cover 100 includes a portion 102 having a top section 102a and a bottom section 102b. The top section 102a of the bottom portion 102 may be made of a material which can be used to paint a wall or any surface. For example, the top section 102a may be made of a paint pad known in the art for painting a wall. The portion 102 may also include a bottom section 102b, shown in FIG. 2C, which may be made of plastic and which may function as a paint leak guard. The portion 102 may be attached to side walls 106a, 106b, 106c, and 106d, which may be made of stretchable, expandable cloth or another material. The side walls 106a, 106b, 106c, and 106d may be attached to peripheral elastic band portions 104a, 104b, 104c, and 104d, respectively.

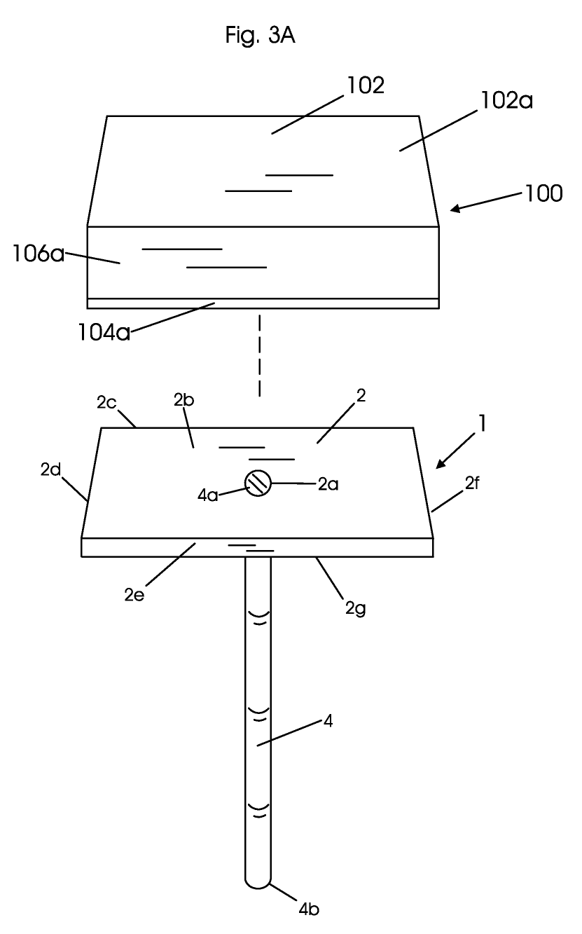

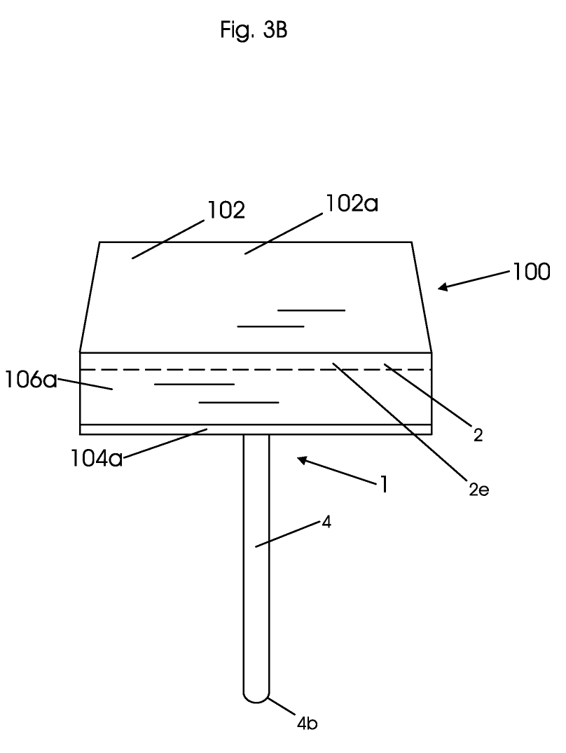

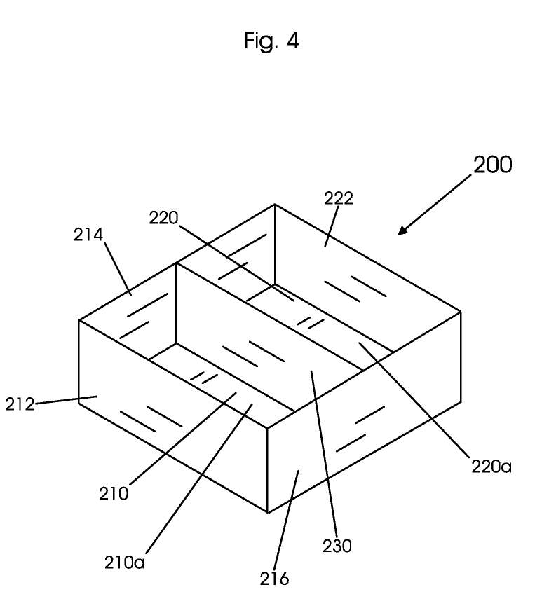

FIG. 3A shows the cover 100 and the painter apparatus 1 in a state where they are not attached together. FIG. 3B shows the cover 100 and the painter apparatus 1 in a state where they are attached together. In FIG. 3B, the cover 100 has been placed over the base 2 of the apparatus 1, so that the side walls 106a, 106b, 106c, and 106d cover the sides 2e, 2f, 2c, and 2d, respectively, and the portion 102 covers the surface 2b of the base 2. Paint can then be applied to the top section 102a of the portion 102. The combined apparatus including painter apparatus 1 and the cover 100 can then be used to paint, such as by applying paint from top section 102a to a wall. In FIG. 3B, a dashed line is shown for explanation purposes to show the location of side 2e of the base 2. However, unless the cover 100 is transparent, the base 2 and the side 2e would not actually be seen in the view of FIG. 3B, since the base 2 is under the cover 100.

The peripheral elastic band portions 104a-104d help to hold the cover 100 onto the base 2 of the apparatus 1. The peripheral elastic band portions 104a-d may be stretchable elastic bands, stretchable cloths, or synthetic fibers. The bottom section 102b of the cover 100 may have a double sided adhesive tape, one side attached to the top section 102a and one side exposed so that it can be attached to the top surface 2b of the base 2.

Stretchable cloth, fabric, plastic, vinyl or another material can be used for the side walls 106a-d to provide a snug fit to the base 2. The top section 102a of the cover 100 may include a synthetic fiber used to absorb paint for painting a wall or other surface.

The top section 102a of the paint cover 100 may be comprised of synthetic fiber, lamb's wool, mohair, stippling, foam, sponge, fabric, stencil, or any material used to absorb and apply paint to a wall or any surface. The top section 102a of the paint cover 100 may have a thickness of ⅛ to one and one half inches, which can be smaller or thicker. The cover 100 may have a length L2 and a width W2, shown in FIG. 2A which may be substantially the same as the length L1 and the width W2, respectively, of the base 2 shown in FIG. 1D.

The peripheral elastic band portions 104a-d can be sewn or glued around the side walls 106a-d, if the side walls 106a-d are made of a fabric or another material. The side walls 106a-d may be made of a stretchable fabric or of another material. The top section 102a of the portion 102 may be made of a disposable or reusable synthetic fiber, which can be removed and/or detached from the bottom section 102b (which may be plastic or plastic combination) and disposed or reused after painting.

The bottom section 102b, shown in FIG. 2C, of the portion 102 may be a leak guard used protect the base 2 from paint. The bottom section 102b may prevent substantially any paint from touching the base 2 after the cover 100 has been placed over the base 2 as in FIG. 3B. The bottom section 102b, shown in FIG. 2C, may be a plastic cover or any non-leaking material to protect the base 2 from paint.

FIG. 4 shows a top perspective view of a pan 200 which can be used with the cover 100 and painter apparatus 1 in accordance with an embodiment of the present invention. The pan 200 may be divided by dividing wall 230 into compartments 210 and 220 which surround chambers 210a and 220a, respectively. Paint can be placed in one of the two compartments, such as compartment 210, while the other compartment, such as 220 can be used to squeeze out excess paint from the cover 100 and apparatus 1. The compartment 210 is surrounded by wall 212, dividing wall 230, and portions of walls 214 and 216. The compartment 220 is surrounded by wall 222, dividing wall 230, and portions of walls 214 and 216.

Each of compartments 210 and 220 may be four feet wide by seven inches long to accommodate a base 2 (and portion 102 of cover 100) of four feet by six inches. The painter pan 200 may be made of plastic, wood, aluminum, a synthesized product of wood, or with various other materials. The painter pan 200 can be smaller or larger depending on the size of the base 2.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus for painting comprising:
a base having a top surface having an area;
a handle;
a means for attaching the base to the handle; and
a cover substantially in the shape of a bag, having a portion at a bottom of the bag, and a plurality of side walls substantially perpendicular to and attached to the portion at the bottom of the bag, so that the portion and the plurality of sidewalls enclose a chamber;
wherein the portion of the cover has a top section made of a material which absorbs paint and allows paint to permeate through the top section,
wherein the top section of the portion of the cover has an area which is approximately equal to the area of the top surface of the base; and
and wherein the base and the cover are configured so that the base can be placed inside of the chamber of the cover, so that the sidewalls of the cover surround the base, and the portion of the cover substantially overlaps the top surface of the base.

2. The apparatus of claim 1 further comprising
a pan having at least a first compartment and a second compartment, wherein each of the first and the second compartments are able to retain paint;
and wherein the base is configured to fit within either the first or the second compartment.

3. The apparatus of claim 1 wherein
the means for attaching the base to the handle includes grooves located on the base and grooves located on the handle.

4. The apparatus of claim 1 wherein
the handle is flexible.

5. The apparatus of claim 1 wherein
the handle has a means for adding a further handle to the handle to effectively elongate the handle.

6. The apparatus of claim 1 wherein
the portion of the cover includes a bottom section made of a material which does not allow paint to permeate through the bottom section.

7. The apparatus of claim 1 wherein
The side walls of the cover are made of a fabric.

8. The apparatus of claim 1 wherein
the side walls of the cover are made of an elastic material.

9. The apparatus of claim 1 wherein
the base is rectangular and approximately six inches in length and four feet in width.

10. The apparatus of claim 7 further comprising
an elastic band which is attached to the side walls, so that the elastic band holds the cover to the base when the cover is placed over the base.

11. A method comprising:
attaching a handle to a base;
attaching a cover to the base;
causing paint to be absorbed by a top section of a portion of the base; and
transferring paint from the top section of the portion of the base to a surface;
wherein the base has a top surface having an area;
wherein the cover is substantially in the shape of a bag, having the portion at the bottom of the bag, and a plurality of side walls substantially perpendicular to and attached to the portion at the bottom of the bag, so that the portion and the plurality of sidewalls enclose a chamber;
wherein the top section of the portion of the cover is made of a material which absorbs paint and allows paint to permeate through the top section,
wherein the top section of the portion of the cover has an area which is approximately equal to the area of the top surface of the base; and
and wherein the base and the cover are configured so that the base can be placed inside of the chamber of the cover, so that the sidewalls of the cover surround the base, and the portion of the cover substantially overlaps the top surface of the base.

12. The method of claim 11 wherein
the portion of the cover includes a bottom section made of a material which does not allow paint to permeate through the bottom section.

13. The method of claim 11 wherein
the side walls of the cover are made of a fabric.

14. The method of claim 11 wherein
the side walls of the cover are made of an elastic material.

15. The method of claim 11 wherein
the base is rectangular and approximately six inches in length and four feet in width.

16. The method of claim 13 further comprising
attaching an elastic band to the side walls, so that the elastic band holds the cover to the base when the cover is placed over the base.

17. The method of claim 11 further comprising
inserting the base into a first compartment of a pan in order to absorb paint;
wherein the pan has at least the first compartment and a second compartment, wherein each of the first and the second compartments are able to retain paint;
and wherein the base is configured to fit within either the first or the second compartment.

18. The method of claim 11 wherein
the base is attached to the handle using grooves located on the base and grooves located on the handle.

19. The method of claim 11 wherein
the handle is comprised of a first portion which is flexible and a second portion which is not flexible.

20. The method of claim 11 further comprising
adding a further handle to the handle to effectively elongate the handle.
